(19) United States
(12) Patent Application Publication
(10) Pub. No.: US 2018/0304622 A1
(43) Pub. Date: Oct. 25, 2018

(54) METHOD OF DISCONNECTING FUSE PORTION OF LIQUID-DISCHARGING HEAD AND LIQUID DISCHARGE APPARATUS

(71) Applicant: CANON KABUSHIKI KAISHA, Tokyo (JP)

(72) Inventors: Tsubasa Funabashi, Kawasaki-shi (JP); Takahiro Matsui, Yokohama-shi (JP); Yoshinori Misumi, Tokyo (JP); Maki Kato, Fuchu-shi (JP); Yuzuru Ishida, Yokohama-shi (JP); Takeru Yasuda, Kawasaki-shi (JP); Norihiro Yoshinari, Tokyo (JP)

(21) Appl. No.: 15/945,179

(22) Filed: Apr. 4, 2018

(30) Foreign Application Priority Data
Apr. 21, 2017 (JP) 2017-084779

(51) Int. Cl. B41J 2/045; B41J 2/14; H01H 85/04

(52) U.S. Cl. CPC B41J 2/04511; B41J 2/0458; H01H 85/04; B41J 2/14072; B41J 2/0457

(57) ABSTRACT

An electric potential difference between both ends of a first fuse portion is increased to more than the electric potential difference that is generated by an electric potential applied to drive print elements in a state where a first print element and a first covering portion are electrically connected to each other.

### BACKGROUND OF THE INVENTION

### Field of the Invention

The present disclosure relates to a method of disconnecting a fuse portion of a liquid-discharging head that discharges a liquid and a liquid discharge apparatus including the liquid-discharging head.

### Description of the Related Art

Currently, liquid discharge apparatuses that are widely used heat a liquid in liquid chambers by energizing heat-generating resistors (print elements) to cause the liquid to foam in the liquid chamber due to film boiling and discharge droplets from discharge ports by using bubble generating energy produced at this time.

In such a liquid discharge apparatus, a region on each heat-generating resistor is physically affected by, for example, an impact of cavitation caused when foaming, shrinkage, and defoaming of the liquid occur in the region on the heat-generating resistor during printing in some cases. When the liquid is discharged, a region on each heat-generating resistor is chemically affected by, for example, solidification and accumulation of the components of the liquid that are pyrolyzed on a surface of the heat-generating resistor because the temperature of the heat-generating resistor is high. In some cases, protective layers (covering portions) formed of, for example, a metallic material are disposed on the heat-generating resistors so as to cover the heat-generating resistors to protect the heat-generating resistors from the physical effect and the chemical effect on the heat-generating resistors.

The protective layers are typically disposed so as to be in contact with the liquid. Accordingly, when an electric current flows through the protective layers, the protective layers may electrochemically react with the liquid and may lose the function. For this reason, an insulation layer is disposed between the heat-generating resistors and the protective layers to prevent a part of electricity to be supplied to the heat-generating resistors from flowing through the protective layers.

However, there is a possibility that the insulation layer loses the function for some reason, and an electric current flows through one of the protective layers directly from the corresponding heat-generating resistor or a wire, that is, a short circuit (electrical connection) occurs. The part of electricity that is to be supplied to the heat-generating resistor but flows through the protective layer causes the protective layer to electrochemically react with the liquid, and the quality of the protective layer changes in some cases. In the case where the protective layers covering the respective heat-generating resistors are electrically connected to each other, there is a risk that an electric current flows through another protective layer other than the protective layer that is short-circuited, and the effect of the change in the quality spreads.

Japanese Patent Laid-Open No. 2014-124923 discloses that protective layers are electrically connected to a common wire with portions to be broken (fuse portions) interposed therebetween. With such a structure, the electric current flowing through one of the protective layers that is short-circuited disconnects the corresponding fuse portion, and this breaks the electric connection with the other protective layers. Consequently, the effect of the change in the quality of the protective layer can be inhibited from spreading.

However, in the case where contact areas between the print elements and the covering portions are small, there is a possibility that the fuse portion is not surely disconnected when the short circuit occurs, because a contact resistance increases and the electric current flowing through the fuse portion decreases. Consequently, even though the fuse portion is provided, there is a risk that the fuse portion is not disconnected, an electric current flows from the covering portion that is short-circuited to the other covering portions, and the effect of the change in the quality of the covering portion spreads over the entire head.

### SUMMARY OF THE INVENTION

The present disclosure provides a liquid discharge apparatus that makes it easy to disconnect the fuse portions disposed between the covering portions and the common wire when the short circuit (electrical connection) occurs between one of the print elements and one of the covering portions to inhibit the effect of the change in the quality of the covering portion from spreading.

The present disclosure further provides a method of disconnecting a fuse portion of a liquid-discharging head. The method includes providing the liquid-discharging head including print elements including a first print element and a second print element, a first covering portion that covers the first print element, a second covering portion that covers the second print element, an insulation layer that is disposed between the first print element and the first covering portion and that is disposed between the second print element and the second covering portion, a common wire that is electrically connected to the first covering portion and the second covering portion, a first fuse portion that electrically connects the first covering portion and the common wire, and a second fuse portion that electrically connects the second covering portion and the common wire. The method includes disconnecting the first fuse portion in a manner in which an electric potential difference between both ends of the first fuse portion is increased to more than the electric potential difference that is generated by an electric potential applied to drive the print elements in a state where the first print element and the first covering portion are electrically connected to each other.

Further features and aspects of the present disclosure will become apparent from the following description of numerous example embodiments with reference to the attached drawings.

### BRIEF DESCRIPTION OF THE DRAWINGS

FIG. 1 illustrates an example liquid discharge apparatus, according to an embodiment of the disclosure.

FIGS. 2A and 2B illustrate an example liquid-discharging head unit and an example liquid-discharging head, according to an embodiment of the disclosure.

FIGS. 3A and 3B illustrate an example liquid-discharging head substrate and the liquid-discharging head, according to an embodiment of the disclosure.

FIGS. 4A to 4C2 illustrate example manufacturing processes of the liquid-discharging head, according to an embodiment of the disclosure.

FIGS. 5A and 5B illustrate circuit diagrams of the liquid-discharging head unit and the main body of a liquid discharge apparatus, according to a “first” example embodiment.

FIG. 6 illustrates a flow of disconnecting one of fuse portions, according to an embodiment of the disclosure.

FIGS. 7A and 7B illustrate circuit diagrams of the liquid-discharging head unit and the main body of a liquid discharge apparatus, according to a “second” example embodiment.

FIGS. 8A and 8B illustrate circuit diagrams of the liquid-discharging head unit and the main body of a liquid discharge apparatus, according to a “third” example embodiment.

### DESCRIPTION OF THE EMBODIMENTS

### Example Liquid Discharge Apparatus

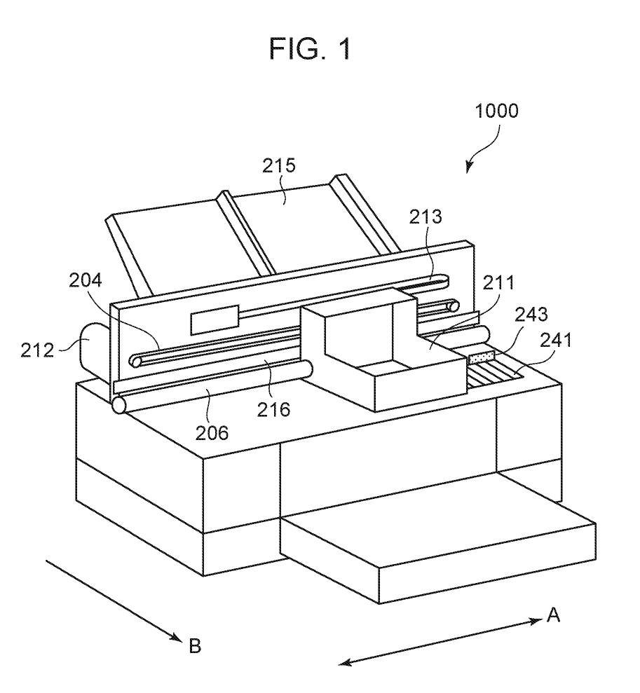

FIG. 1 is a perspective view of a liquid discharge apparatus 1000 according to aspects of embodiments of the present disclosure. The liquid discharge apparatus 1000 illustrated in FIG. 1 includes a carriage 211 that accommodates a liquid-discharging head unit 410. In the liquid discharge apparatus 1000 according to the present embodiment, the carriage 211 is movably guided along a guide shaft 206 in a main scanning direction of an arrow A. The guide shaft 206 extends in a width direction of a record medium. Accordingly, a liquid-discharging head installed in the carriage 211 is scanned in a direction intersecting a conveyance direction in which the record medium is conveyed for recording. The liquid discharge apparatus 1000 is a so-called serial-scan-type liquid discharge apparatus that records an image while a liquid-discharging head 1 moves in the main scanning direction and the record medium is conveyed in a sub-scanning direction.

The carriage 211 is supported by the guide shaft 206 extending there through so as to be scanned in a direction perpendicular to the conveyance direction of the record medium. A belt 204 is mounted on the carriage 211. A carriage motor 212 is mounted on the belt 204. Thus, a driving force of the carriage motor 212 is transmitted to the carriage 211 via the belt 204, and the carriage 211 can move in the main scanning direction while being guided by the guide shaft 206.

A flexible cable 213 via which electric signals from a control unit are transmitted to the liquid-discharging head of the liquid-discharging head unit 410 is attached to the carriage 211 and connected to the liquid-discharging head unit. The liquid discharge apparatus 1000 includes a cap 241 and a wiper blade 243 that are used for a recovery process of the liquid-discharging head. The liquid discharge apparatus 1000 also includes a paper-feeding unit 215 that stores record media stacked, and an encoder sensor 216 that optically senses the position of the carriage 211.

### Example Liquid-Discharging Head Unit

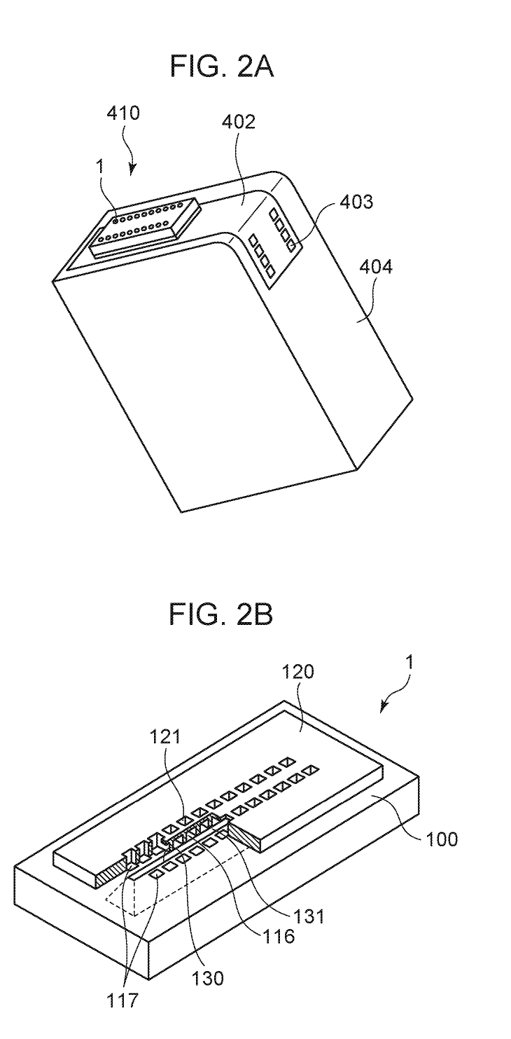

FIG. 2A is a perspective view of the liquid-discharging head unit 410. The liquid-discharging head unit 410 is a cartridge unit including the liquid-discharging head and a tank that are integrally formed. The liquid-discharging head unit 410 is attachable to and detachable from the inside of the carriage. The liquid-discharging head unit 410 includes the liquid-discharging head 1. A tape member 402 for TAB (Tape Automated Bonding) that includes a terminal for power supply is attached to the liquid-discharging head unit 410. The liquid discharge apparatus selectively supplies power to heat-generating resistors 108 via the tape member 402. When the power is supplied to the heat-generating resistors 108, the power is transmitted via the tape member 402 from contacts 403 and supplied to the liquid-discharging head 1. The liquid-discharging head unit 410 includes a tank 404 that temporarily stores a liquid, which is supplied to the liquid-discharging head 1 therefrom.

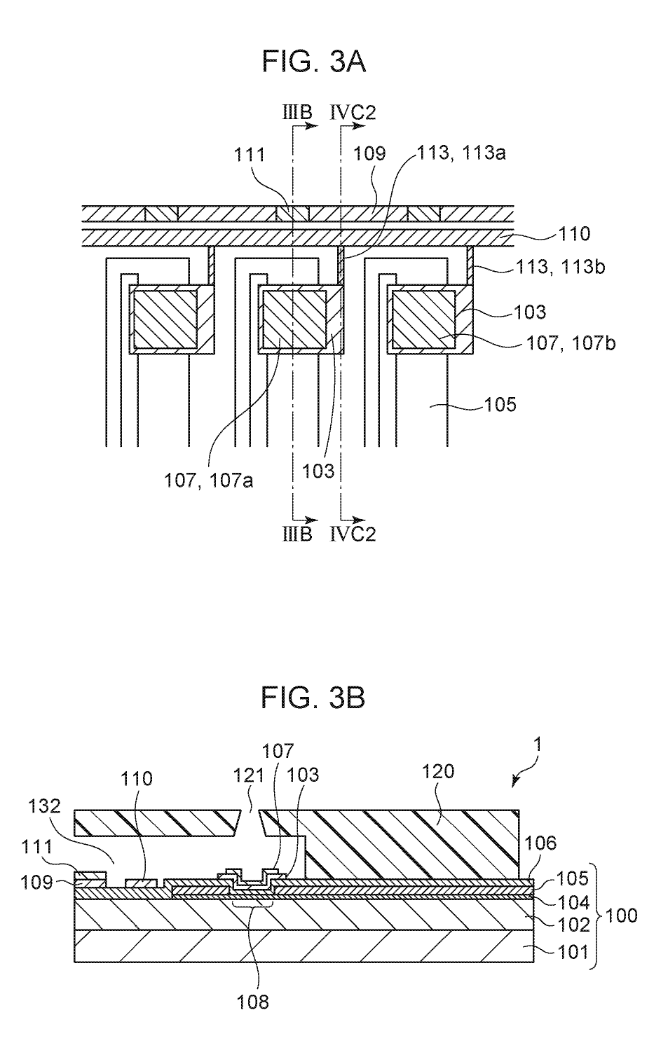

FIG. 2B is a perspective view of the liquid-discharging head 1 a part of which is omitted. The liquid-discharging head 1 according to the present embodiment is formed of a liquid-discharging head substrate 100 and a channel-forming member 120 attached thereto. Liquid chambers 132 (see FIG. 3B) that can store a liquid are defined between the channel-forming member 120 and the liquid-discharging head substrate 100. The liquid-discharging head substrate 100 includes a liquid supply port 130 extending from a front surface of the liquid-discharging head substrate 100 to a back surface thereof. The channel-forming member 120 includes a common liquid chamber 131 in communication with the liquid supply port 130. The channel-forming member 120 also includes liquid channels 116 extending from the common liquid chamber 131 to the corresponding liquid chambers 132. Thus, the channel-forming member 120 is formed such that the common liquid chamber 131 and the liquid chambers 132 are in communication with each other with the liquid channels 116 interposed therebetween. In the liquid chambers 132, heat-generating portions 117 are formed. In the channel-forming member 120, discharge ports 121 are formed at positions corresponding to the heat-generating portions 117. The heat-generating portions 117 (heat-generating resistors 108) are arranged in rows. The discharge ports 121 corresponding to the heat-generating portions 117 are also arranged in rows.

A surface of the liquid-discharging head substrate 100 from which the liquid is discharged is referred to as the front surface here. A surface of the liquid-discharging head substrate 100 opposite the surface from which the liquid is discharged is referred to as the back surface.

When the liquid is supplied from the tank 404 to the liquid-discharging head 1, the liquid is supplied to the common liquid chamber 131 via the liquid supply port 130 of the liquid-discharging head substrate 100. The liquid supplied to the common liquid chamber 131 passes through the liquid channels 116 and is supplied to the inside of the liquid chambers 132. At this time, the liquid in the common liquid chamber 131 is supplied to the liquid channels 116 and the liquid chambers 132 due to capillarity and forms a meniscus in the discharge ports 121. This enables the surface of the liquid to be stable.

The heat-generating resistors 108 are disposed at lower parts of the heat-generating portions 117. When the liquid is discharged, the heat-generating resistors 108 are energized by using wires. When the heat-generating resistors 108 are energized, the heat-generating resistors 108 generate thermal energy, which heats the liquid in the liquid chambers 132 and causes the liquid to foam due to film boiling. At this time, bubble generating energy is produced, and consequently, droplets are discharged from the discharge ports 121.

The liquid-discharging head unit 410 is not limited to a structure integrally formed with the tank according to the present embodiment. For example, the liquid-discharging head and the tank may be separated from each other. This enables the tank alone to be detached when the liquid in the tank is exhausted and enables the tank alone to be replaced with a new tank. Accordingly, it is not necessary for the tank and the liquid-discharging head to be replaced together, and the frequency at which the liquid-discharging head is replaced is decreased to reduce the operation cost of the liquid discharge apparatus.

In the liquid discharge apparatus, the liquid-discharging head and the tank may be disposed at different locations, and may be connected to each other by using, for example, a tube to supply the liquid to the liquid-discharging head. According to the present embodiment, the liquid discharge apparatus includes a serial-scan-type recording head that is scanned in the main scanning direction A. The present disclosure, however, is not limited thereto. The present disclosure can be used for a full-line-type liquid discharge apparatus including a liquid-discharging head extending over the range corresponding to the entire width of the record medium that is used in, for example, a line printer.

### Example Liquid-Discharging Head

FIG. 3A is a schematic plan view of the vicinity of the heat-generating portions of the liquid-discharging head substrate 100 according to the embodiment of the present disclosure viewed from above. FIG. 3B is a schematic sectional view of the liquid-discharging head 1 taken along line IIIB-IIIB in FIG. 3A.

The liquid-discharging head 1 includes the liquid-discharging head substrate 100 formed of a silicon base 101 on which layers are stacked. A heat storage layer 102 formed of, for example, a thermal oxide film, a SiO film, or a SiN film is disposed on the base 101. A heat-generating resistor layer 104 formed of, for example, TaSiN is disposed on the heat storage layer 102 and serves as a wire. An electrode wiring layer 105 formed of, for example, a metallic material such as Al, Al—Si, or Al—Cu is disposed on the heat-generating resistor layer 104. An insulating protection layer 106 is disposed on the electrode wiring layer 105. The insulating protection layer 106 is disposed on the upper side of the heat-generating resistor layer 104 and the electrode wiring layer 105 so as to cover the heat-generating resistor layer 104 and the electrode wiring layer 105. The insulating protection layer 106 is formed of, for example, a SiO film, a SiN film, or a SiCN film.

Upper protective layers 107 are disposed on the insulating protection layer 106. The upper protective layers 107 protect surfaces of the heat-generating resistors 108 from a chemical or physical impact due to heat generated by the heat-generating resistors 108. According to the present embodiment, each upper protective layer 107 is formed of a platinum group such as iridium (Ir) or ruthenium (Ru), or tantalum (Ta) and has a thickness of 20 to 100 nm. The upper protective layers 107 formed of such a material are conductive. When the liquid is discharged, surfaces of the upper protective layers 107 are in contact with the liquid, the temperature of the liquid on the surfaces of the upper protective layers 107 instantaneously increases and the liquid foams and defoams. Thus, the surfaces are in a harsh environment in which a cavitation occurs. For this reason, according to the present embodiment, the upper protective layers 107 each formed of a reliable material having a high corrosion resistance are disposed at the positions corresponding to the heat-generating resistors 108. To increase the durability of the liquid-discharging head 1, Ir that has a high resistance against a physical impact or a chemical effect such as the cavitation is preferably used to form the upper protective layers 107.

The upper protective layers 107 cover the respective heat-generating resistors 108. That is, one of the upper protective layers 107 (107a) serving as a first covering portion covers one of the heat-generating resistors 108 serving as a first print element. Another upper protective layer 107 (107b) serving as a second covering portion covers another heat-generating resistor 108 serving as a second print element.

The heat-generating resistors 108 are formed in a manner in which portions of the electrode wiring layer 105 are removed. According to the present embodiment, the heat-generating resistor layer 104 and the electrode wiring layer 105 are superposed in a direction from the liquid supply port 130 toward the liquid chambers 132 and have substantially the same shape. Portions of the electrode wiring layer 105 are removed to form gaps in which there is no electrode wiring layer 105, and portions of the heat-generating resistor layer 104 are exposed therefrom. Thus, two layers of the heat-generating resistor layer 104 and the electrode wiring layer 105 are formed, portions of the electrode wiring layer 105 corresponding to portions of the heat-generating resistor layer 104 that function as the heat-generating resistors 108 are removed to expose the portions of the heat-generating resistor layer 104. The electrode wiring layer 105 is connected to a drive element circuit or an external power terminal, not illustrated, and can be supplied with power from the outside.

According to the above embodiment, the electrode wiring layer 105 is disposed on the heat-generating resistor layer 104. The present invention, however, is not limited thereto. The electrode wiring layer 105 may be formed on the base 101 or the heat storage layer 102, portions of the electrode wiring layer 105 may be removed to form gaps, and the heat-generating resistor layer 104 may be disposed on the electrode wiring layer 105. A plug electrode such as a tungsten plug may be connected to the heat-generating resistor layer 104 instead of the electrode wiring layer 105 to form the heat-generating resistors 108.

Conductive protective layers 103 covering the respective heat-generating resistors 108 are disposed on surfaces of the upper protective layers 107 facing the heat-generating resistors 108. As illustrated in FIG. 3A, one of the upper protective layers 107 (107a) covering the corresponding heat-generating resistor 108 is electrically connected to another upper protective layer 107 (107b) covering another heat-generating resistor 108 with the corresponding conductive protective layer 103 and a common wire 110 interposed therebetween. The common wire 110 extends in the direction of discharge port rows (direction in which the heat-generating resistors 108 are arranged). The conductive protective layers 103 and the common wire 110 are connected to each other with fuse portions 113 interposed therebetween. The fuse portions 113 are easily broken when an electric current flows there through. The protective layers 103, the common wire 110, and the fuse portions 113 have a thickness of 20 to 100 nm. Each fuse portion 113 has a thin portion that is easily broken and has a width (length in the transverse direction) of, for example, 2 μm to 5 μm. According to the present embodiment, the protective layers 103, the common wire 110, and the fuse portions 113 are formed so as to be in contact with the liquid in the liquid chambers 132. The protective layers 103, the common wire 110, and the fuse portions 113 are each formed of Ta. The formation of these components with the same material enables the components to be manufactured in the same manufacturing process. It is only necessary for the material to be conductive. However, the material is preferably Ru, Ta, or an alloy containing Ru or Ta.

According to the present embodiment, the upper protective layers 107 are electrically connected to each other with the protective layers 103 that are lower layers of the upper protective layers 107 interposed therebetween. The upper protective layers 107 may be connected directly to the common wire without these layers.

According to the present embodiment, the upper protective layers 107 are electrically connected to each other, and this facilitates an electric leakage check between the upper protective layers and the heat-generating resistor layer 104 and enables a cleaning process described later to be performed.

The liquid discharge apparatus according to the present embodiment can periodically perform a cleaning process to remove kogation accumulated on the upper protective layers 107. The upper protective layers 107 and facing electrodes 111 are disposed in the liquid chambers 132. The surfaces of the upper protective layers 107 to which the kogation attaches are dissolved by an electrochemical reaction with the liquid. Each facing electrode 111 is formed of Ir. A facing electrode wire 109 connected to the facing electrodes 111 is formed of Ta. The cleaning process involves applying 0 V (the same electric potential as GND) to the facing electrodes 111 and a positive electric potential of +5 to +10 V to the upper protective layers 107 and dissolving the surfaces of the upper protective layers 107 in the liquid to remove the kogation from the upper protective layers 107. It is only necessary for the upper protective layers 107 and the facing electrodes 111 to contain either or both of Ir and Ru to perform the cleaning process of removing the kogation.

In the case where the liquid contains particles having an electric charge, the particles can be appropriately removed from the liquid that is on the surfaces of the upper protective layers 107 and that is to be discharged in a manner in which an electric potential having a polarity opposite the polarity of the electric potential of the particles in the liquid is applied to the facing electrodes 111. This inhibits the particles from adsorbing to the surfaces of the upper protective layers 107 due to heat generated when the heat-generating resistors 108 are driven and inhibits kogation from occurring on the surfaces of the upper protective layers 107. For example, in the case where the liquid contains particles having a negative charge, the particles can be attracted to the facing electrodes 111 in a manner in which a positive electric potential of about +0.5 V to +2 V is applied to the facing electrodes 111. While a print operation is not performed, an external power supply 302 may stop application of the electric potential to the facing electrodes 111.

### Example Method of Manufacturing Liquid-Discharging Head

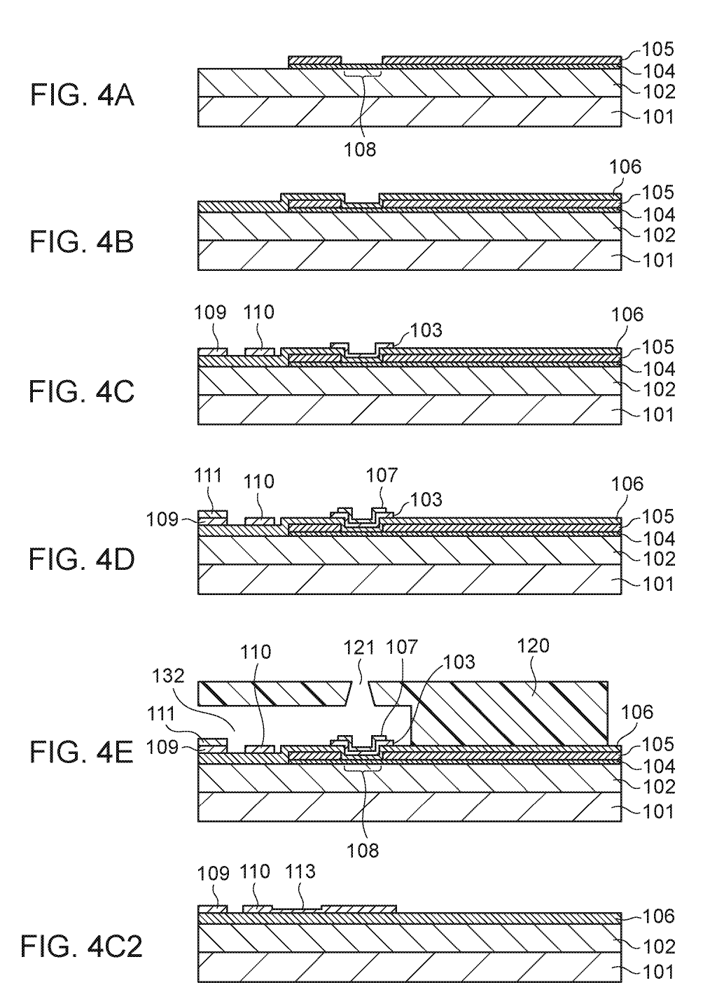

Example manufacturing processes of the liquid-discharging head 1 will herein be described with reference to a schematic sectional view of the liquid-discharging head 1 in FIGS. 4A to 4E.

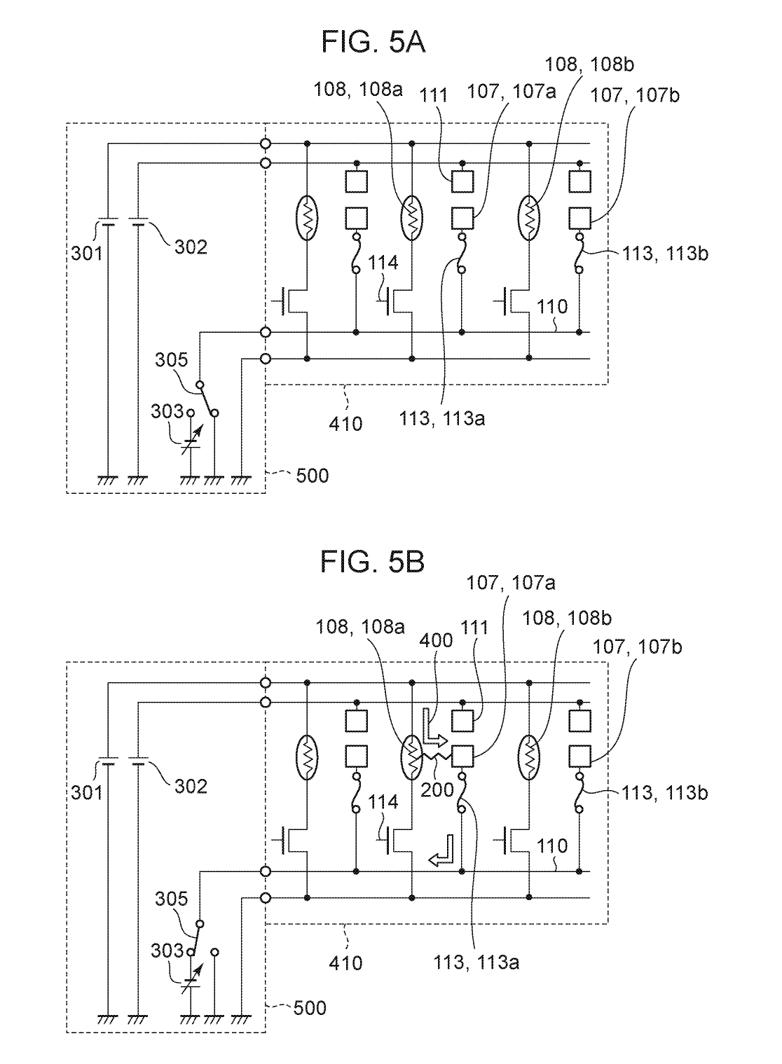

In typical manufacturing processes of the liquid-discharging head 1, drive circuits are built on the Si base 101, and subsequently, the layers are stacked on the base 101 to manufacture the liquid-discharging head 1. The drive circuits, for example, semiconductor elements such as switching transistors 114 (see FIGS. 5A and 5B) for selectively driving the heat-generating resistors 108 are built on the base 101 in advance, and the layers are stacked thereon to form the liquid-discharging head 1. The drive circuits that are built in advance, for example, are omitted in FIGS. 4A to 4C2 for simplicity. A method of forming each layer, and the material and thickness of the layer are described below by way of example. The present invention, however, is not limited to the description below.

The heat storage layer 102, which is a lower layer of the heat-generating resistor layer 104, is formed of a SiO₂ thermal oxide film on the base 101 by, for example, a thermal oxidation method, a sputtering method, or a CVD method. The heat storage layer 102 can be formed while the drive circuits are built on the base.

Subsequently, the heat-generating resistor layer 104 having a thickness of about 20 nm is formed of, for example, TaSiN on the heat storage layer 102 by reactive sputtering. An Al layer having a thickness of about 300 nm is formed on the heat-generating resistor layer 104 by spattering to form the electrode wiring layer 105. The heat-generating resistor layer 104 and the electrode wiring layer 105 are dry-etched in photolithography at the same time. This removes portions of the heat-generating resistor layer 104 and the electrode wiring layer 105. According to the present embodiment, the dry etching is reactive ion etching (RIE). To form the heat-generating resistors 108, portions of the electrode wiring layer 105 are removed by wet etching, and portions of the heat-generating resistor layer 104 are exposed therefrom.

Subsequently, as illustrated in FIG. 4B, a SiN film having a thickness of about 200 nm is formed by a plasma CVD method to form the insulating protection layer 106.

Subsequently, a Ta layer having a thickness of about 100 nm is formed on the insulating protection layer 106 by spattering to form the protective layers 103, the fuse portions 113, the common wire 110, and the facing electrode wire 109. Subsequently, portions of the Ta layer are removed by dry etching in photolithography to form the protective layers 103, the common wire 110, the fuse portions 113, and the facing electrode wire 109 (see FIG. 4C). The fuse portions 113 (see FIG. 3A) electrically connect the common wire 110 and the protective layers 103 to each other. The width of each fuse portion 113 is 2 μm, which corresponds to the lower limit dimension of photolithography. When an electric current flows through the fuse portions 113, the current densities of the fuse portions 113 increase, and the fuse portions 113 are easily broken.

FIG. 4C2 illustrates a section along line IVC2-IVC2 in FIG. 3A. As illustrated in FIG. 4C2, a portion of each fuse portion 113 may be thinly formed so as to have a thickness of 50 nm to make the fuse portion 113 easy to break. In this case, after the state in FIG. 4C, a part of each fuse portion 113 formed of Ta is removed by dry etching in photolithography to decrease the thickness thereof. This adjusts the Ta film thickness of each fuse portion 113 to 50 nm, which is near a half of a film thickness of about 100 nm of the common wire 110 and the facing electrode wire 109 that are formed of Ta.

Subsequently, an Ir layer having a thickness of 30 nm is formed by spattering to form the upper protective layers 107 and the facing electrodes 111. Portions of the Ir layer are removed by dry etching in Photolithography to form the upper protective layers 107 covering the heat-generating resistors 108, and the facing electrodes 111 used to remove the kogation (see FIG. 4D).

Subsequently, a resist layer that is a soluble solid layer is applied to the surface of the liquid-discharging head substrate 100 in FIG. 4D on the side on which the upper protective layers 107 are formed by spin coating. An example of the material of the resist layer is polymethyl isopropenyl ketone, and this resist serves as a negative resist. The resist layer is patterned into the desired shape of the liquid chambers 132 in photolithography. Subsequently, a resin coating layer is formed to form the channel-forming member 120 defining liquid channel walls and the discharge ports 121. Before the coating resin layer is formed, a silane coupling treatment may be appropriately used to improve adhesion. The coating resin layer is formed by applying a resin to the liquid-discharging head substrate 100, on which the resist layer that is patterned into the shape of the liquid chambers 132 is formed, by an appropriate method selected from known coating methods. Subsequently, the coating resin layer is patterned into the desired shape of the liquid channel walls and the discharge ports 121 in photolithography. Subsequently, the liquid supply port 130 extending through the liquid-discharging head substrate 100 is formed from the back surface of the substrate 100 by using an anisotropic etching method, a sandblasting method, or an anisotropic plasma etching (not illustrated). At this time, the liquid supply port 130 is formed by silicon anisotropic chemical etching that uses, for example, tetramethyl hydroxylamine (TMAH), NaOH, or KOH. Subsequently, the entire surface is exposed to deep-UV light, and the resist later is removed by development and drying to form the liquid chambers 132.

Through the above processes, the liquid-discharging head 1 can be manufactured.

### First Example Embodiment

FIGS. 5A and 5B illustrate circuit diagrams of the liquid-discharging head unit 410 and the main body 500 of the liquid discharge apparatus according to a first example embodiment. FIG. 5A illustrates a normal state. FIG. 5B illustrates a state where a short circuit occurs between one of the heat-generating resistors 108 and one of the upper protective layers 107.

The heat-generating resistors 108 are selected by a drive power supply 301 (voltage applying unit), the switching transistors 114, and a selection circuit, not illustrated, and driven. According to the present embodiment, the drive power supply 301 is disposed in the main body 500 of the liquid discharge apparatus outside the liquid-discharging head unit 410 and supplies, for example, a drive voltage of 20 to 35 V. The drive power supply 301 described herein supplies a voltage of 24 V. With this structure, the heat-generating resistors 108 can be supplied with power from the drive power supply 301 at any time, and droplets can be discharged from the discharge ports at any time.

The insulating protection layer 106 that functions as an insulation layer is disposed between the heat-generating resistors 108 and the upper protective layers 107 as described above, and the heat-generating resistors 108 and the upper protective layers 107 are not electrically connected to each other. The upper protective layers 107 (107a and 107b) including the first covering portion and the second covering portion are connected to the common wire 110 with the protective layers 103 (not illustrated in FIGS. 5A and 5B) and the fuse portions 113 interposed therebetween. The common wire 110 can be connected to an external power supply 303 (voltage applying unit) with a switch 305 interposed therebetween. The switch 305 can connect the common wire 110 to the external power supply 303. The external power supply 303 applies a variable voltage but may apply a constant voltage.

In the case where the liquid contains particles having a negative charge, the facing electrodes 111 are connected to the external power supply 302, and a positive electric potential is applied thereto. The particles contained in the liquid can be attracted from the upper protective layers 107 to the facing electrodes 111. This enables kogation to be inhibited from attaching to the surfaces of the upper protective layers 107. When the kogation is removed, the facing electrodes 111 may be connected to another power supply, and the voltage that the external power supply 302 applies may be made variable to generate the desired electric potential difference between the upper protective layers 107 and the facing electrodes 111.

In some cases, a short circuit (electrical connection) occurs between one of the heat-generating resistors 108 (108a) and one of the upper protective layers 107 (107a) due to an accidental failure for some reason when the liquid is discharged. As illustrated in FIG. 5B, when a short circuit 200 occurs between the heat-generating resistor 108 and the upper protective layer 107, an electric current 400 flows from the heat-generating resistor 108 (108a) to the upper protective layer 107 (107a). For example, breakage of one of the heat-generating resistors 108 results in breakage of the insulating protection layer 106 in some cases. At this time, there is a possibility that a part of the heat-generating resistor 108 and a part of the corresponding upper protective layer 107 melt, the parts come into direct contact with each other, and the short circuit 200 occurs.

In the case where the upper protective layers 107 are each formed of Ta, the upper protective layers 107 electrochemically react with the liquid, and anodization starts. There is a risk that progress of the anodization makes the lifetime of the upper protective layers 107 shorter because oxidized Ta is likely to dissolve in the liquid. In the case where the upper protective layers 107 are each formed of Ir or Ru, electrochemical reactions between the upper protective layers 107 and the liquid cause the upper protective layers 107 to dissolve in the liquid, and accordingly, there is a risk that the durability of the upper protective layers 107 decreases. While the liquid is stored in the liquid chambers 132, the electric potential of the liquid is lower than the drive electric potential of each heat-generating resistor 108. Accordingly, when the short circuit occurs between one of the heat-generating resistors 108 and one of the upper protective layers 107, the upper protective layer 107 has an electric potential higher than that of the liquid, and an electrochemical reaction is likely to occur between the upper protective layer 107 and the liquid.

When the short circuit 200 occurs between the heat-generating resistor 108 (108a) and the upper protective layer 107 (107a), there is a possibility that an electric current flows through another upper protective layer 107 (107b) covering another heat-generating resistor 108 (108b) via the common wire 110. In this case, the short circuit affects the other upper protective layer 107 (107b) that is not short-circuited. Thus, there is a possibility that the effect of a change in the quality of one of the upper protective layers 107 due to the electrochemical reaction such as the anodization and dissolution spreads over a wide range.

According to the present embodiment, the upper protective layers 107 (107a and 107b) are connected to the common wire 110 with the corresponding fuse portions 113 (113a and 113b) interposed therebetween. Accordingly, when the short circuit occurs between the heat-generating resistor 108 (108a) and the upper protective layer 107 (107a), and the electric current flows through the upper protective layer 107 (107a), the electric current flows also through the corresponding fuse portion 113 (first fuse portion 113a). The fuse portion 113 is thinner than the upper protective layer 107 and the common wire 110, and can be broken (electrically insulated) because the current density of the fuse portion 113 increases. Consequently, the other upper protective layers 107 can be inhibited from being affected by the short circuit.

However, there is a possibility that the fuse portion 113 is not broken, and this depends on the state of the short circuit between the heat-generating resistor 108 and the upper protective layer 107. For example, in the case where the contact area between the heat-generating resistor 108 and the upper protective layer 107 is small, the contact resistance of the short circuit is large, the intensity of the electric current flowing through the fuse portion 113 is low. Accordingly, in some cases, the fuse portion 113 is not broken.

In view of this, according to the present embodiment of the present invention, a structure that ensures the breakage of the fuse portion 113 (113a) to be broken is proposed.

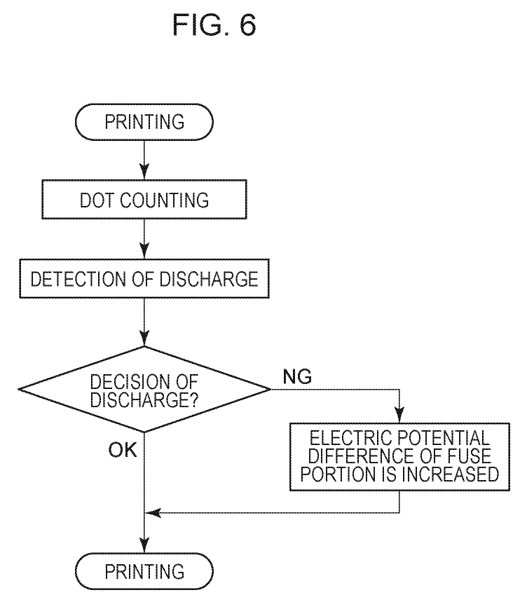

The liquid discharge apparatus 1000 periodically detects discharge with a predetermined timing, for example, in a manner in which the member of discharge is counted by dot counting. FIG. 6 illustrates a flow of disconnecting one of the fuse portions 113. When the number of discharge reaches a predetermined number after printing starts, discharge is detected by dot counting. When a discharge failure of one of the discharge ports that does not normally discharge a droplet is detected (in the case of NG), as illustrated in FIG. 5B, the switch 305 is switched from 0 V to the external power supply 303, and the common wire 110 is connected to the external power supply 303. The external power supply 303 can apply a negative electric potential to the upper protective layers 107 via the common wire 110. For example, the external power supply 303 applies a negative electric potential of −10 V. At this time, the drive power supply 301 applies a positive electric potential of +24 V.

In this case, when a short circuit occurs between one of the heat-generating resistors 108 and one of the upper protective layers 107, the drive power supply 301 applies a positive electric potential of +24 V to the heat-generating resistor 108, and the external power supply 303 applies a negative electric potential of −10 V to the upper protective layer 107. Accordingly, an electric potential difference of 34 V (=24 V+10 V) is generated between both ends of the wire including the corresponding fuse portion 113, a large electric current flows, and the fuse portion 113 can be disconnected with certainty. After the electric potential difference between both ends of the fuse portion 113 is increased to disconnect the fuse portion 113 with certainty, printing is resumed.

According to the present embodiment, the electric potential difference between both ends of the fuse portion 113 (113a) is thus increased to more than the electric potential difference when the short circuit (electrical connection) occurs to disconnect the fuse portion 113 (113a) with certainty. Thus, when a short circuit occurs between one of the heat-generating resistors 108 and one of the upper protective layers 107, the short circuit does not affect the other upper protective layers 107, and the effect of the short circuit can be inhibited from spreading over the entire liquid-discharging head.

The other discharge ports complement the discharge port that does not normally discharge a droplet. According to the present embodiment, it is not necessary to replace the liquid-discharging head, or the number of times the liquid-discharging head is replaced can be decreased, the lifetime of the liquid-discharging head can be increased, and the running costs of the liquid discharge apparatus can be reduced.

According to the present embodiment, the electric potential is applied via the common wire 110, and accordingly, it is not necessary to provide a power supply that can supply a voltage higher than that of the power supply for driving the heat-generating resistors 108.

The time during which the external power supply 303 applies the electric potential is preferably 1 sec or less. The reason is that applying a negative electric potential to the upper protective layers 107 for a long time may cause the material (Ir) of the facing electrodes 111 to dissolve in the liquid. When the time is 1 sec or less, the material can be prevented from dissolving due to the electrochemical reaction, or the effect of dissolution can be reduced. The time during which the negative electric potential is applied via the upper protective layers 107 is preferably 5 msec or more to disconnect the fuse portion 113 with certainty. Accordingly, the time during which the external power supply 303 applies the electric potential is preferably no less than 5 msec and no more than 1 sec.

A preferable range of the electric potential that the external power supply 303 connected to the common wire 110 applies will now be described. From the perspective of disconnection of a target fuse portion 113, the electric potential difference between both ends of the fuse portion 113 is preferably increased, that is, a negative electric potential that the external power supply 303 applies is preferably decreased. The increase in the electric potential difference between both ends of the fuse portion 113 may cause unnecessary electrochemical reactions of the upper protective layers 107 and the facing electrodes 111. When the upper protective layers 107 electrochemically react with the liquid, hydrogen ions in the liquid are reduced to hydrogen atoms, and two hydrogen atoms are held together to form a hydrogen molecule. The hydrogen molecule is occluded by, for example, the protective layers 103 that are connected to the upper protective layers 107 and that are formed of Ta or the common wire 110, and the possibility of hydrogen embrittlement (crack) of Ta increases. When the facing electrodes 111 electrochemically react with the liquid, the possibility of dissolution of the material of the facing electrodes 111 increases.

Specifically, when the external power supply 303 applies a negative electric potential of less than −18 V, for example, −20 V for 10 msec, the effects of the hydrogen embrittlement of the protective layers 103 and the dissolution of the facing electrodes 111 increase, and this has been confirmed. When a negative electric potential of −5 V to −18 V is applied for 10 msec, the effects of the hydrogen embrittlement and the dissolution are acceptable. When a negative electric potential of more than −5 V, for example, −2 V is applied for 10 msec, the fuse portions 113 to be disconnected are not disconnected in some cases. When a negative electric potential of −5 V or less is applied for 10 msec, the fuse portions 113 are disconnected with certainty, and this has been confirmed. It is revealed that the electric potential that the external power supply 303 connected to the common wire 110 applies is preferably in the range of no less than −5 V and no more than −18 V. In the above cases, the external power supply 303 applies the negative electric potential in a state where the external power supply 302 does not apply an electric potential to the facing electrodes 111.

Examples of the method of detecting discharge include detecting the presence or absence of a discharged droplet with an optical sensor, detecting discharge by scanning recording patterns with a scanner, and detecting discharge by using resistance variations of the heat-generating resistors. The method is not limited provided that the discharge-detecting unit can detect whether droplets are normally discharged from the discharge ports.

### Second Example Embodiment

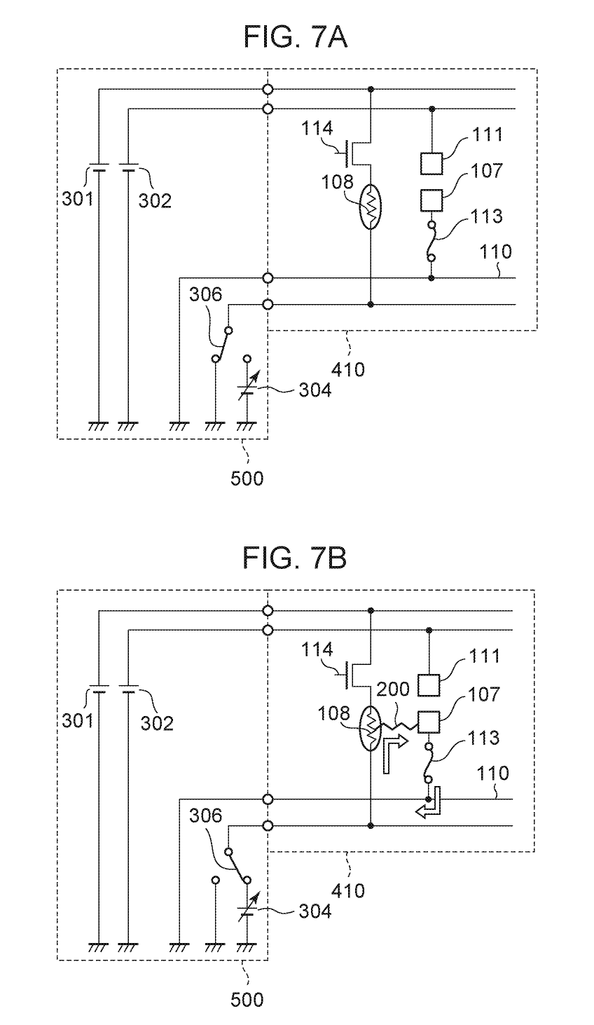

FIGS. 7A and 7B illustrate circuit diagrams of the liquid-discharging head unit 410 and the main body 500 of a liquid discharge apparatus according to a second embodiment. FIG. 7A illustrates a normal state. FIG. 7B illustrates a state where a short circuit occurs between one of the heat-generating resistors 108 and one of the upper protective layers 107. Although FIGS. 7A and 7B illustrate only the heat-generating resistor 108 and the upper protective layer 107, the liquid-discharging head 1 includes the heat-generating resistors 108 and the upper protective layers 107 covering the heat-generating resistors 108 as in the embodiments described above.

According to the present embodiment, as illustrated in FIG. 7A, the switching transistors 114 are disposed between the heat-generating resistors 108 and the drive power supply 301 unlike the above embodiments. The voltage of the upper protective layers 107 is 0 V. An end of each heat-generating resistor 108 that is not connected to the corresponding switching transistor 114 is connected to a switch 306. When the heat-generating resistors 108 are driven, the switching transistors 114 connected to the heat-generating resistors 108 to be driven are switched on, and the heat-generating resistors 108 are supplied with power from the drive power supply 301 that applies a drive voltage of 24 V.

As illustrated in FIG. 7B, when the result of detection of discharge is NG, that is, when one of the discharge ports that does not normally discharge a droplet is detected, the switch 306 is switched from 0 V to a power supply 304. The power supply 304 applies an electric potential of, for example, +30 V, which is an electric potential higher than a drive voltage +24 V that the drive power supply 301 applies when the heat-generating resistors 108 are driven.

Thus, an electric current flows from the power supply 304, passes through the corresponding heat-generating resistor 108, the short circuit between the heat-generating resistor 108 and the corresponding upper protective layer 107, and the upper protective layer 107, and flows through the corresponding fuse portion 113. A voltage applied across both ends of the fuse portion 113 when the switch 306 is switched to the power supply 304 is higher than the voltage applied across both ends of the fuse portion 113 when the short circuit occurs. Accordingly, the electric current flowing through the fuse portion 113 can be increased, and the fuse portion 113 can be disconnected with certainty. According to the present embodiment, it is not necessary to apply a negative electric potential to the upper protective layers 107, and it is not necessary to provide the external power supply 303 that is to be connected to the upper protective layers 107 according to the above embodiments.

### Third Example Embodiment

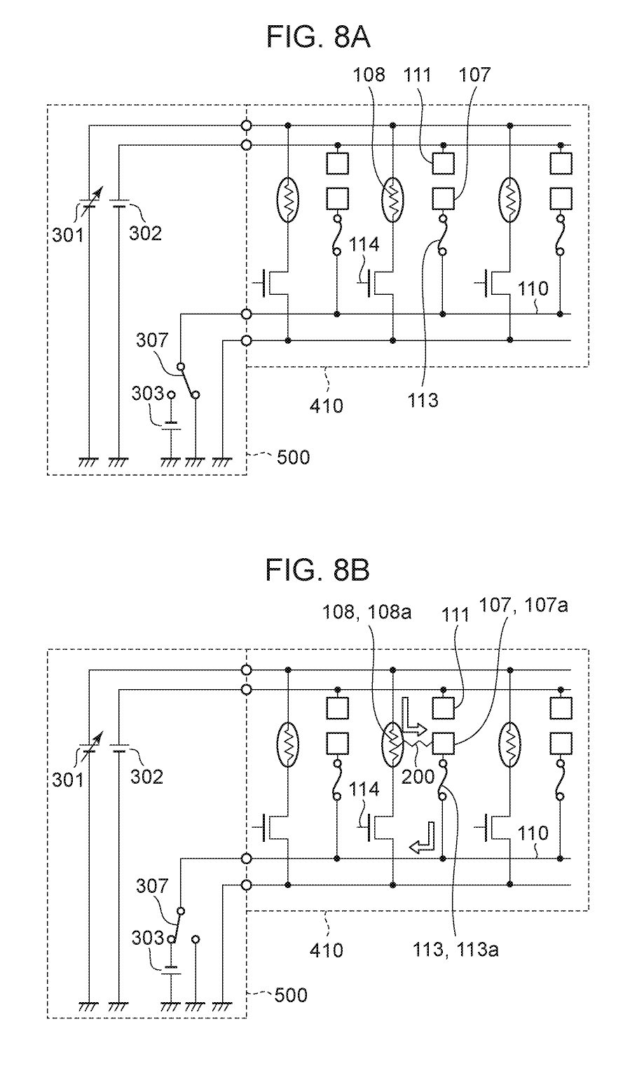

FIGS. 8A and 8B illustrate circuit diagrams of the liquid-discharging head unit 410 and the main body 500 of a liquid discharge apparatus according to a third example embodiment. FIG. 8A illustrates a normal state. FIG. 8B illustrates a state where a short circuit occurs between one of the heat-generating resistors 108 and one of the upper protective layers 107.

As illustrated in FIG. 8A, the drive power supply 301 for driving the heat-generating resistors 108 applies a variable voltage. In the state of normal discharge, that is, the state of printing, the drive power supply 301 applies a voltage of +24 V.

When the result of detection of discharge is NG, as illustrated in FIG. 8B, a switch 307 connected to the upper protective layers 107 is switched from 0 V to the external power supply 303 that applies a negative electric potential of −10 V. The voltage of the drive power supply 301 is changed from +24 V to +30 V.

Thus, when the short circuit occurs between the heat-generating resistor 108 and the upper protective layer 107, the drive power supply 301 applies a positive electric potential of +30 V to the heat-generating resistor 108, and the external power supply 303 applies a negative electric potential of −10 V to the upper protective layer 107. Accordingly, an electric potential difference of 40 V (=30 V−(−10 V)) is generated between both ends of the wire including the corresponding fuse portion 113, a large electric current flows, and the fuse portion 113 can be disconnected with certainty.

According to the present embodiment, a higher electric potential of the heat-generating resistor 108 is increased. However, a lower electric potential thereof may be increased depending on the circuit configuration.

### Fourth Example Embodiment

In the method described according to the above embodiments, the discharge-detecting unit is provided to detect discharge, and the intensity of the electric current flowing to the target fuse portion 113 is increased in accordance with the result of detection. However, the intensity of the electric current flowing to the fuse portion 113 may be increased with a predetermined timing without detecting discharge. The power supply is connected with a predetermined timing, and consequently, the electric current flowing to the fuse portion 113 increases when the short circuit occurs between the heat-generating resistor 108 and the upper protective layer 107, and the fuse portion 113 to be disconnected can be disconnected with certainty.

According to a fourth embodiment, for example, in the case of FIG. 5A, the switch 305 connected to the common wire 110 is switched between the GND and −10 V of the external power supply 303 with a predetermined timing. During print operation, the switch 305 connects the common wire 110 to the GND. For example, in the case of continuous recording on the record media, during a non-print operation after recording on a record medium is finished and before recording on a next record medium is started, the switch 305 connects the common wire 110 to the external power supply 303. During the non-print operation, in which no print operation is carried out, the external power supply 303 and the common wire 110 are periodically connected to each other.

This enables a large electric current to flow to the fuse portion 113 corresponding to the short circuit 200 in a state where the common wire 110 is connected to the external power supply 303, and the print operation (discharge of the liquid) is not disturbed. Accordingly, the fuse portion 113 can be disconnected with certainty. The fuse portion 113 is disconnected with certainty without using the discharge-detecting unit, and the effect of the change in the quality of the upper protective layer 107 can be inhibited from spreading.

The time during which the external power supply 303 and the common wire 110 are connected to each other is preferably 5 msec or more to disconnect the fuse portion 113 to be disconnect with certainty. The timing with which the switch 305 is switched is not limited to the above description unless the print operation is disturbed, and may be irregular.

According to the present embodiment, discharge is not detected, and the power supply for disconnecting the fuse portion 113 with certainty is connected when no short circuit occurs. Accordingly, when the present embodiment is used in the case where the power supply 304 is connected to the heat-generating resistors 108 to disconnect the fuse portion 113 as in the second embodiment, an electric potential higher than the drive power supply is unnecessarily applied to the heat-generating resistors 108 that are not short-circuited. From the perspective of this, the external power supply 303 connected to the common wire 110 preferably applies the electric potential to disconnect the fuse portion 113 as in the first embodiment.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-084779 filed Apr. 21, 2017, which is hereby incorporated by reference herein in its entirety.

What is claimed is:

1. A method of disconnecting a fuse portion of a liquid-discharging head, the method comprising:
providing the liquid-discharging head including print elements including a first print element and a second print element, a first covering portion that covers the first print element, a second covering portion that covers the second print element, an insulation layer that is disposed between the first print element and the first covering portion and that is disposed between the second print element and the second covering portion, a common wire that is electrically connected to the first covering portion and the second covering portion, a first fuse portion that electrically connects the first covering portion and the common wire, and a second fuse portion that electrically connects the second covering portion and the common wire; and
disconnecting the first fuse portion in a manner in which an electric potential difference between both ends of the first fuse portion is increased to more than the electric potential difference that is generated by an electric potential applied to drive the print elements in a state where the first print element and the first covering portion are electrically connected to each other.

2. The method of disconnecting the fuse portion of the liquid-discharging head according to claim 1,
wherein a voltage applying unit connected to the common wire applies an electric potential to increase the electric potential difference.

3. The method of disconnecting the fuse portion of the liquid-discharging head according to claim 2,
wherein the voltage applying unit applies a negative electric potential to increase the electric potential difference.

4. The method of disconnecting the fuse portion of the liquid-discharging head according to claim 1,
wherein a voltage applying unit connected to the first print element applies an electric potential to increase the electric potential difference.

5. The method of disconnecting the fuse portion of the liquid-discharging head according to claim 1,
wherein the electric potential difference is periodically increased.

6. The method of disconnecting the fuse portion of the liquid-discharging head according to claim 1,
wherein the electric potential difference is increased during a non-print operation of the liquid-discharging head.

7. The method of disconnecting the fuse portion of the liquid-discharging head according to claim 1,
wherein discharge from the liquid-discharging head is detected, and the electric potential difference is increased in a case that a discharge failure of a discharge port corresponding to the first print element is detected.

8. The method of disconnecting the fuse portion of the liquid-discharging head according to claim 2,
wherein a time during which the voltage applying unit applies the electric potential is no less than 5 ms and no more than 1 s.

9. The method of disconnecting the fuse portion of the liquid-discharging head according to claim 3,
wherein the voltage applying unit applies an electric potential of no less than −5 V and no more than −18 V to increase the electric potential difference.

10. A liquid discharge apparatus comprising:
a liquid-discharging head including print elements including a first print element and a second print element, a first covering portion that covers the first print element, a second covering portion that covers the second print element, an insulation layer that is disposed between the first print element and the first covering portion and that is disposed between the second print element and the second covering portion, a common wire that is electrically connected to the first covering portion and the second covering portion, a first fuse portion that electrically connects the first covering portion and the common wire, and a second fuse portion that electrically connects the second covering portion and the common wire;
a first voltage applying unit configured to apply a voltage to the print elements to drive the print elements; and
a second voltage applying unit configured to increase an electric potential difference between both ends of the first fuse portion to more than the electric potential difference that is generated by the first voltage applying unit to drive the print elements in a state where the first print element and the first covering portion are electrically connected to each other.

11. The liquid discharge apparatus according to claim 10,
wherein the second voltage applying unit applies an electric potential via the common wire to increase the electric potential difference.

12. The liquid discharge apparatus according to claim 11,
wherein the second voltage applying unit applies a negative electric potential to increase the electric potential difference.

13. The liquid discharge apparatus according to claim 10,
wherein the second voltage applying unit applies an electric potential via the first print element to increase the electric potential difference.

14. The liquid discharge apparatus according to claim 10,
wherein the second voltage applying unit periodically increases the electric potential difference.

15. The liquid discharge apparatus according to claim 10,
wherein the second voltage applying unit increases the electric potential difference during a non-print operation of the liquid-discharging head.

16. The liquid discharge apparatus according to claim 10 further comprising:
a discharge-detecting unit configured to detect a discharge state of the liquid-discharging head,
wherein the second voltage applying unit increases the electric potential difference in a case that the discharge-detecting unit detects a discharge failure of a discharge port corresponding to the first print element.
